(19) United States
(12) Patent Application Publication
(10) Pub. No.: US 2009/0017355 A1
(43) Pub. Date: Jan. 15, 2009

(54) SOLID POLYMER FUEL CELL

(75) Inventors: Norihiko Kawabata, Osaka (JP); Hiroki Kusakabe, Osaka (JP); Takashi Morimoto, Osaka (JP); Toshihiro Matsumoto, Osaka (JP); Yoshiki Nagao, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/815,121

(22) PCT Filed: Nov. 24, 2006
(86) PCT No.: PCT/JP2006/323496

§ 371 Date: Jul. 31, 2007

(30) Foreign Application Priority Data
Nov. 25, 2005 (JP) 2005-339944

(51) Int. Cl. H01M 8/10; H01M 8/02; H01M 8/24

(52) U.S. Cl. 429/30; 429/27; 429/34; 29/623.1

(57) ABSTRACT

A solid polymer fuel cell stack. A fuel cell which can uniformly supply gas in a short time to all stacked cells not only in a steady state operation but also in a transient operation state, such as start, stop, or load variation operation, is provided. In each cell included in the solid polymer fuel cell stack, an intake manifold is divided into a connection space with a separator channel and one more space by forming a protrusion or a bridge portion in the intake manifold, and the structure of the protrusion or the bridge portion is adjusted depending on each cell.

### TECHNICAL FIELD

The present invention relates to a fuel cell employing a solid polymer electrolyte membrane.

### BACKGROUND ART

Fuel cells employing solid polymer electrolyte membranes generate power and heat simultaneously by electrochemically reacting fuel gas containing hydrogen with oxidizing gas containing oxygen such as air etc. The fuel cell typically has a polymer electrolyte membrane selectively transporting hydrogen ions and a pair of electrodes sandwiching the solid polymer electrolyte membrane. Each electrode is comprised of a catalyst layer mainly composed of carbon powder and a platinum metallic catalyst supported on the carbon powder, and a gas diffusion layer having both gas permeability and electronic conductivity.

Fuel cells employing a solid polymer electrolyte membrane are also provided with gas sealant or a gasket surrounding the polymer electrolyte membranes at the periphery of the electrodes so that supplied fuel gas and oxidizing gas does not leak to outside or become mixed together. The gas sealant or gasket is typically assembled integrally with the solid polymer electrolyte membrane and electrode and this assembly may be referred to as “MEA (Membrane Electrolyte Assembly).” The MEA is then sandwiched by conductive separators. The separators mechanically fix the MEA and electrically connect stacked MEAs in series. Flow paths are then formed on contact area of the separator with the MEA, reactive gas is then supplied to the electrodes via the flow paths, and generated water and excess gas is then exhausted via the flow path. The flow paths are typically formed on separators but may also be formed separated from the separators.

Gas pipe is also provided at the fuel cell for supplying reactive gas to flow paths and for exhausting gas from the flow paths formed on the separators. This gas pipe branches according to the number of separators and destinations of the branches are connected to the flow paths formed on the separators. A pipe jig for achieving this connection is referred to as a “manifold.”

The material for the polymer electrolyte membrane is typically a perfluorocarbon sulfonic acid resin. The polymer electrolyte membrane exhibits ion electric conductivity in a state containing fluid. Therefore, it is generally necessary to supply humidified fuel gas and oxidizing gas and it is also desirable to make the relative humidity of these gases close to 100% or more in order to give a high-performance fuel cell. However, as water is generated as a result of a reaction on the cathode side of the fuel cell, when gas is humidified and supplied so as to have a higher dew point than the operating temperature of the cell, dew condensation occurs in the electrodes and in the flow path within the cell, which results in instability and lowering of cell performance as a result of phenomena such as water clogging.

Such a instability or lowering of cell performance due to excess wetting (occurrence of dew condensation) is generally referred to as “flattening phenomena.” When the flattening phenomena occurs on the anode side, it becomes difficult to supply the fuel gas and the required amount of the fuel gas is not supplied. When the load current is forcibly extracted in a state where the fuel gas is insufficient, carbon provided to the anode side catalyst reacts with water within the atmosphere so as to generate electrons and protons. As a result, carbon of the catalyst layer is eluted and the catalyst layer is broken down. When this situation continues, the cathode potential that is positive compared to the anode becomes less than 0 volts. This kind of state is referred to as “polarity inversion” which is a fatal state for the cell.

At the time of steady operation, several proposals are made in order to prevent the gas from being supplied insufficiently as a result of the flattening phenomena causing dew condensation on the upstream of the flow path of the supplied gases having a relative humidity of 100% or more as described above (refer to patent document 1).

For example,

1) The cross-section of the manifold for supplying gas from outside has a constricting part which is formed between a communicating part for the manifold and the gas flow path, and gas pipe;
2) The gas pipe connected to the manifold extends to within the manifold, and a gas supplying hole is provided on the upper surface of the extended gas pipe; and
3) Gas pipe connected to the manifold extends within the manifold, gas supply holes are provided on the upper surface of the extended gas pipe, and the gaps between the holes for gas supplying become narrower as the points of connection with the manifold become further away.

On the other hand, with solid polymer fuel cells, it is important to prevent reactive gases from crossing each other. Because of this, the manifold formed at the separator is made grid shaped etc, in order to make forming a flow path groove on the frame unnecessary so that the structure can be simplified. As a result, it is possible to minimize changes in the frame and it is proposed to minimize gas crossing (refer to patent document 2).

### Patent Document 1: Japanese Patent Application Laid-Open No. 2004-327425.

### Patent Document 2: Japanese Patent Application Laid-Open No. 2004-165043.

### DISCLOSURE OF INVENTION

### Problems to be Solved by the Invention

Other than operating in the steady state described above, the fuel cell also operates under transient conditions where operating conditions frequently change, such as start-up, stopping, or changing load, etc. When operating under transient conditions, it is also desirable to stably switch over operation and to prevent deterioration of performance due to the switching over operation.

In order to prevent deterioration of the catalyst of a fuel cell using a solid polymer electrolyte membrane at the time of the stopping, the path is typically filled up with gas such as nitrogen and raw fuels prior to reforming such as 13A etc. as filler gas which is held and maintained in the path. When normal gas is inputted at the time of the start-up, the filler gas is expelled and the catalyst becomes active. After this, the anode electrode is filled with protons, and the potential of the cathode electrode is made sufficiently high with respect to the anode electrode. This makes it possible to extract the load current. When it is attempted to extract load current from one or more of the stacked fuel cells contained in the fuel cell stack regardless of being in a state prior to load current extraction being possible, this fuel cell enters the “polarity inversion” state described above. It is therefore not allowed to start power generation until all of the stacked fuel cells reach a state where the load current can be extracted.

However, variation in the timing of reaching a state where each of the fuel cells contained in the cell stack can start to generate power depending on the direction of stacking of the fuel cells. The cathode of the fuel cell firstly becoming capable of generating power is held at a high potential for a long time compared to that of other fuel cells. This promotes deterioration of the catalyst when this situation continues. It is therefore preferable for normal gas inputted at the time of start-up to be dispersed over all of the fuel cells at as the same time as possible. However, it is difficult to accurately measure the time taken from the gas being inputted to the fuel cell firstly becoming capable of generating power. In practice it is desirable for normal gas entering at the time of the start-up to be dispersed over all of the fuel cells in as short a period as possible.

Further, in the event of going from a state of normal operation to stopping state, nitrogen and raw fuels prior to reforming such as 13A etc. are inputted as filler gas. In this case also, it is desirable for the filler gas to fill all of the fuel cells in as short a period as possible.

In addition, there are also cases where the amount of gas flowing is changed so as to change the extracted load current. For example, when the load current is made smaller, the load current is changed and then the amount of gas is changed, and, when the load current is made larger, the amount of gas is changed and then the load current is changed. It is also desirable for the gas for which the amount flowing is changed to be dispersed to all of the fuel cells in as short a period as possible.

The present invention therefore provides a fuel cell for a solid polymer fuel cell stack capable of providing gas in a short period of time and in a uniform manner to all stacked fuel cells, not just during times of normal operation, but also during transient operation such as during start-up, when stopping, or when the load changes. In this way, it is possible to provide solid polymer fuel cells that allow stable operation switching and that minimize deterioration in performance due to the switching.

A proposal for supplying gas in a uniform manner to all stacked fuel cells is suggested in US 2005/0271910. This discloses a manifold which is divided into a fluid supply manifold and a fluid distribution manifold by a transition channel. As a result, a gas flow is stabilized. However, the supply of gas in a short period and in a uniform manner to all fuel cells, is difficult with just these proposals.

### Means for Solving the Problem

A first aspect of the present invention relates to a fuel cell stack described in the following:

[1] A solid polymer fuel cell stack including a plurality of fuel cells stacked in series, each fuel cell comprising: a polymer electrolyte membrane; a pair of electrodes comprising a fuel electrode and an oxidizing electrode, and sandwiching the polymer electrolyte membrane and; a pair of separators comprising a separator connected to the fuel electrode and having a flow path where fuel gas flows, and a separator connected to the oxidizing electrode and having a flow path where oxidizing gas flows; a supply manifold that supplies fuel gas to the separator flow path where the fuel gas flows and an exhaust manifold that exhausts the fuel gas; and a supply manifold that supplies oxidizing gas to the separator flow path where the oxidizing gas flows, and an exhaust manifold that exhausts the oxidizing gas, wherein: an internal space of at least one of the supply manifold and the exhaust manifold is divided into two spaces mutually communicating that comprise a space connected with the separator flow path and an other space by projecting part or bridging part provided at an inner wall; and the projecting part or the bridging part control inflow of gas into the space connected with the separator flow path, and the control of the inflow of gas varies between the plurality of stacked fuel cells and the inflow of gas at fuel cell of inner layer is controlled to be minimal compared with the inflow of gas at fuel cells at end parts in a stacking direction.
[2] The fuel cell stack according to [1], wherein the inflow of gas is controlled to be minimal at fuel cell of inner layer positioned half-way or less across the whole of the stacked fuel cells from a side where gas is supplied from outside.
[3] The fuel cell stack according to [1] or [2], wherein the supply manifold supplying fuel gas to the flow path where the fuel gas flows and the exhaust manifold that exhausts the fuel gas, and the supply manifold supplying oxidizing gas to the flow path where the oxidizing gas flows and the exhaust manifold that exhausts the oxidizing gas, are formed in a frame; and the solid polymer electrolyte membrane, and the pair of electrodes comprised of the fuel electrode and the oxidizing electrode and sandwiching the solid polymer electrolyte membrane are accommodated in the frame.
[4] The fuel cell stack according to [3], wherein a sealant sealing the separator flow path from outside, is formed integrally in the frame.
[5] The fuel cell stack according to any one of [1] to [4], wherein the every space connected with separator flow path of the manifold of the plurality of stacked fuel cells communicates with each other.
[6] The fuel cell stack according to any one of [1] to [5], wherein the space connected with the separator flow path of the manifold is arranged upwards from the other space with respect to the gravitational direction.
[7] The fuel cell stack according to any one of [1] to [6], wherein the projecting part projects toward the electrode side from an outer periphery side of the fuel cell.
[8] The fuel cell stack according to any one of [1] to [7], wherein the size of the projecting part or the bridging part is not uniform between the plurality of stacked fuel cells and is maximum at the fuel cell of the inner layer.
[9] The fuel cell stack according to any one of [1] to [7], wherein the height of the projecting part is not uniform between the plurality of stacked fuel cells and is maximum at the fuel cell of the inner layer.
[10] The fuel cell stack according to any one of [1] to [7], wherein the projecting part or bridging part contained at the respective plurality of stacked fuel cells is flat straightening plate; and an angle of a longitudinal direction of the straightening plate and the stacking direction of the fuel cells is not uniform, and minimal at the fuel cell of the inner layer.
[11] The fuel cell stack according to any one of [1] to [7], wherein part of the projecting part or bridging part contained at the respective plurality of stacked fuel cells is thicker in the stacking direction than other portion, and the part has an annular structure having a ejecting opening on its side; the every part is tightly fitted with each other to form a pipe, and gas supply pipe from the outside is connected to the formed pipe; and an area of the ejecting opening is not uniform and is minimal at the fuel cell at the inner layer.
[12] The fuel cell stack according to [11], wherein the ejecting opening faces in a direction opposite to the space connected with the separator flow path.

A second aspect of the present invention relates to a frame for fuel cells and a method for producing thereof described in the following:

[13] A frame comprising: a polymer electrolyte membrane; a pair of electrodes comprising a fuel electrode and an oxidizing electrode, and sandwiching the polymer electrolyte membrane; and a supply manifold that supplies fuel gas to the separator flow path where the fuel gas flows and an exhaust manifold that exhausts the fuel gas; and a supply manifold that supplies oxidizing gas to the separator flow path where the oxidizing gas flows, and an exhaust manifold that exhausts the oxidizing gas, wherein: an internal space of at least one of the supply manifold and the exhaust manifold is divided into a space connected with the separator flow path and an other space by a projecting part provided at an inner wall, and the projecting part has one notch or two or more notches, and the projecting part can be cut at the notch.
[14] A method for producing a frame including: a polymer electrolyte membrane; a pair of electrodes comprising a fuel electrode and an oxidizing electrode, and sandwiching the polymer electrolyte membrane; and a supply manifold that supplies fuel gas to the separator flow path where the fuel gas flows and an exhaust manifold that exhausts the fuel gas; and a supply manifold that supplies oxidizing gas to the separator flow path where the oxidizing gas flows, and an exhaust manifold that exhausts the oxidizing gas, wherein an internal space of at least one of the supply manifold and the exhaust manifold is divided into a space connected with the separator flow path and an other space by a projecting part or a bridging part provided at an inner wall, wherein the method comprising injecting resin into a die through a gate provided at the projecting part or the bridging part.

### ADVANTAGEOUS EFFECT OF THE INVENTION

According to a polymer electrolyte fuel cell stack of the present invention, it is possible to provide gas in a short period of time and in a uniform manner to all stacked fuel cells, not just during times of normal operation, but also during transient operation such as during start-up, when stopping, or when the load changes. It is therefore possible to stably switch over operation and minimize deterioration in performance due to the switching, and improve durability of the fuel cell.

### BRIEF DESCRIPTION OF THE DRAWINGS

FIG. 1 is a front view from the cathode side (FIG. 1A) and a front view from the anode side (FIG. 1B) of a frame-integrated MEA used in a fuel cell stack of embodiment 1;

FIG. 2 is a front view from the cathode side (FIG. 2A) and a front view from the anode side (FIG. 2B) of a cathode-side separator of a frame-integrated MEA used in a fuel cell stack of embodiment 1;

FIG. 3 is a perspective view of a fuel cell stack of embodiment 1;

FIG. 4 is a front view from the cathode side of a frame-integrated MEA used in a fuel cell of embodiment 2;

FIG. 5 is a perspective view of a fuel cell stack of embodiment 2;

FIG. 6 is an enlarged perspective view of a cathode side supply manifold of a fuel cell stack of embodiment 3;

FIG. 7 is an enlarged perspective view of a cathode side supply manifold of a fuel cell stack of embodiment 4;

FIG. 8 is an enlarged perspective view of a cathode side supply manifold of a fuel cell stack of embodiment 5;

FIG. 9 is an enlarged perspective view of a cathode side supply manifold of a fuel cell stack of embodiment 6;

FIG. 10 is an enlarged perspective view of a cathode side supply manifold of a fuel cell stack of embodiment 7;

FIG. 11 is an enlarged perspective view of a cathode side supply manifold of a fuel cell stack of embodiment 8;

FIG. 12 is an enlarged perspective view of a cathode side supply manifold of a fuel cell stack of embodiment 9;

FIG. 13 is an enlarged perspective view of a cathode side supply manifold of a fuel cell stack of embodiment 10;

FIG. 14 is an enlarged perspective view of a frame-integrated MEA of embodiment 11;

FIG. 15 is a further enlarged perspective view of a frame-integrated MEA of the embodiment 11;

FIG. 16 is an enlarged perspective view of a supply manifold of a fuel cell stack of comparative example 1;

FIG. 17 is an enlarged perspective view of a supply manifold of a fuel cell stack of comparative example 2;

FIG. 18 is a front view of a frame-integrated MEA of a fuel cell stack of comparative example 3;

FIG. 19 is a view showing simulation results for concentration distribution of air within a cathode side supply manifold for two seconds after the start of inflow of air from supply gas pipe at the time of start-up of the fuel cell stack of comparative example 1;

FIG. 20 is a view showing simulation results for concentration distribution of air within a cathode side supply manifold for two seconds after the start of inflow of air from supply gas pipe at the time of start-up of the fuel cell stack of comparative example 2; and

FIG. 21 is a view showing simulation results for concentration distribution of air within a cathode side supply manifold for two seconds after the start of inflow of air from supply gas pipe at the time of start-up of the fuel cell stack of embodiment 1.

### BEST MODE FOR CARRYING OUT THE INVENTION

A fuel cell stack of the present invention includes a plurality of stacked solid polymer fuel cells. The plurality of stacked fuel cells is preferably connected to each other in series.

Each fuel cell preferably has: (1) a polymer electrolyte membrane; (2) a pair of electrodes comprised of a fuel electrode and an oxidizing electrode, and sandwiching the polymer electrolyte membrane; (3) a pair of separators comprised of a separator connected to the fuel electrode and having a flow path where fuel gas flows, and a separator connected to the oxidizing electrode and having a flow path where oxidizing gas flows; (4) a manifold for supplying/exhausting fuel gas to/from the separator flow path where the fuel gas flows; and (5) a manifold for supplying/exhausting oxidizing gas to/from the separator flow path where the oxidizing gas flows. Each fuel cell may also further have arbitrary members.

The polymer electrolyte membrane is not limited as long as it is a thin membrane that allows hydrogen ions to pass but does not allow electrons to pass. Typically, a fluororesin membrane is employed.

The pair of electrodes sandwiching the polymer electrolyte membrane comprise an oxidizing electrode (referred to as “cathode”) supplied with oxidizing agent and a fuel electrode (referred to as “anode”) supplied with fuel gas. Although this is not specifically limited, each electrode may be carbon supporting a catalyst of platinum.

Separators are arranged so as to make contact at the pair of electrodes, and reactive gas is supplied via the separators. Namely, it is preferable for a flow path where fuel gas flows to be formed on a separator arranged at a fuel electrode, and for a path where oxidizing gas flows to be formed on the separator arranged at the oxidizing electrode. The shape of the flow path (hereinafter also referred to as “separator flow path”) formed on the separators is not particularly limited but may, for example, be a serpentine shape.

The separator is preferably conductive, and may be a mold made of thermosetting resin or thermoplastic resin, or a pressed metal plate, etc. In the case when the pressed metal plate is used as a separator, a projecting part or a bridging part (described later) may also be formed as screws.

A supply manifold for supplying gas and an exhaust manifold for exhausting gas (also collectively referred to as the “manifold for supplying and exhausting gas”) are connected to the respective separators which gas flow path is formed on. A gas supply pipe from outside is connected to the supply manifold and a gas exhaust pipe to outside is connected to the exhaust manifold.

In the present invention, an internal space of at least one of the manifold for supplying and exhausting fuel gas and the manifold for supplying and exhausting oxidizing gas is divided into a “space connected with the separator flow path” and “the other space.” Both spaces communicate with each other and gas is capable of moving between the two.

The “space connected with the separator flow path” may be a space containing a section for connecting with the separator flow path of the manifold. “The other space” may be (1) a space along the axis of an external gas supply pipe or a space along the axis of a gas exhaust pipe going to outside (also referred to as a “the supplying/exhaust pipe section”), or (2) a space for a buffer section that ensures that gas supplied from outside does not enter directly into a space connected with a separator flow path, or a space for a buffer section that ensures that gas exhausted from a separator flow path does not flow directly to outside at the exhaust pipe (also referred to as a “buffer section”).

The separating may carried out with “projecting part” or “bridging part” provided on inner walls of the inner space of the manifold. “Projecting part” refers to member that partially projects from an inner wall rather than bridges an internal space. “Bridging part” refers to member spanning an internal space.

The projecting part may also be formed at arbitrary positions of the inner wall of the manifold and one or more of the projecting part may be formed. If projecting parts are provided in opposing positions of the inner wall, a “constriction” is formed. Here, the projecting part is preferably formed on the outer peripheral side at the inner wall of the manifold. Namely, it is preferable for the projecting part to face from the outer peripheral side towards the electrode side.

When projecting part is provided on the outer periphery side at an inner wall, it becomes difficult to discharge heat generated by a reaction occurring at the fuel cell to outside compared to the case where projecting part is provided on an inner periphery side at an inner wall. Because of this, the heat can be efficiently collected and this contributes to cogeneration.

The bridging part is a member bridging an internal space of the manifold, and, rather than completely separating the space connected with the separator flow path and the other space. Namely the bridging part has a portion (gas passing portion) for allowing these two spaces to communicate with each other.

The projecting part or the bridging part can control the inflow of gas supplied from outside to the “space connected with the separator flow path” of the internal space of the manifold. The control of the inflow is carried out according to the structure of the projecting part or bridging part. For example, the following situation can be considered but this is not particularly limiting.

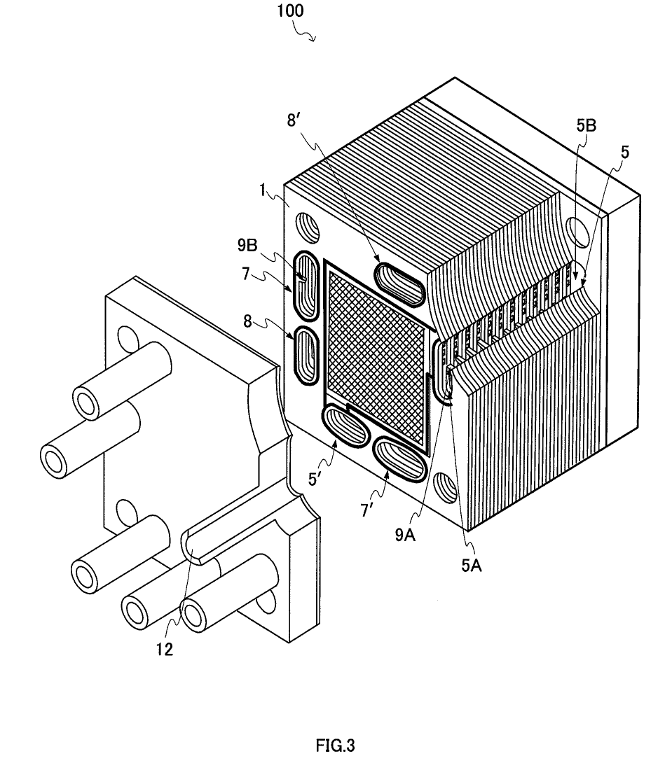

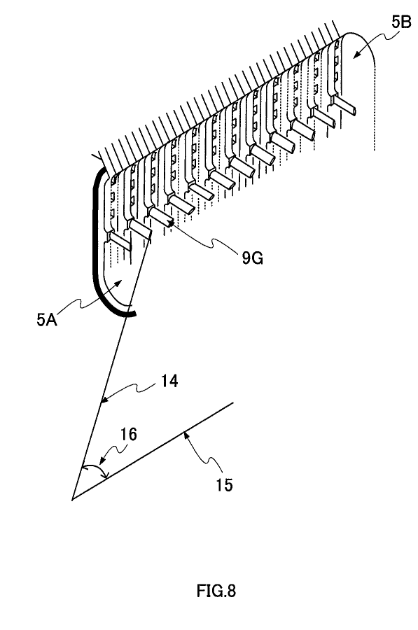

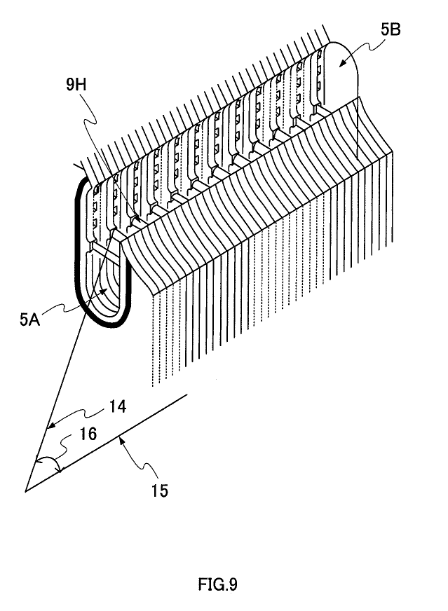

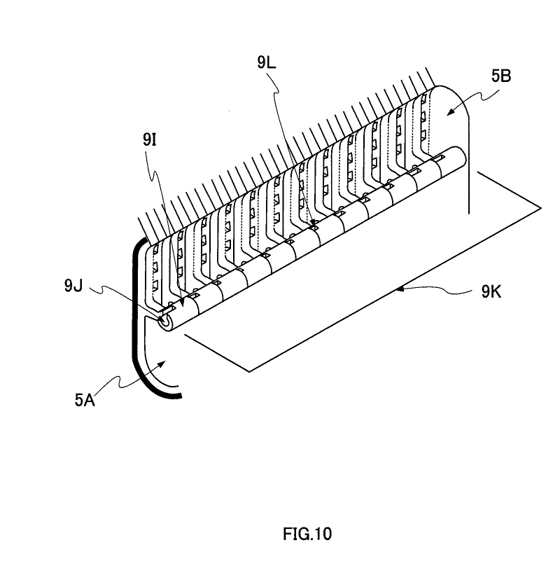

1) The surface area of the communicating portion to the space connected with the separator flow path is adjusted by adjusting the size (for example, the height of the projecting part) of the projecting part or bridging part, and the inflow is controlled (refer to FIGS. 3, 5, and 7). “Size of the bridging part” may mean “the size of the cross-sectional area orthogonal with the longitudinal direction.” “Size of the projecting part” may mean “volume of the projecting part.” “Height of the projection” may mean “the length of the projection in a projection direction from the inner wall of the manifold.” In any of these cases, these are by no means limiting as long as the size of the surface area of the portion communicating with a space connected with the separator flow path is adjusted.
2) The projecting part or bridging part is a current plate, and the inflow is then controlled by adjusting the angle at which the current plate is arranged (refer to FIG. 8 and FIG. 9, etc.).
3) A part of the projecting part or bridging part is made thick and the thick part have a pipe structure which has an ejecting opening on its side. A plurality of the parts that are made thick is then connected to each other to form a pipe, and a gas pipe is connected from outside. The inflow is controlled by adjusting the area of the ejecting opening (refer to FIG. 10 to FIG. 13 etc.).

The projecting part or bridging part is preferably formed at one or both of the supply manifold for supplying oxidizing gas and the supply manifold for supplying fuel gas but may also be formed at an exhaust manifold for exhausting oxidizing gas or fuel gas. When a projecting part or bridging part is provided at the exhaust manifold, it is possible to reduce shifts in the timing in which gas from the separator flow path of each cell is exhausted.

The projecting part or the bridging part may be provided at a manifold formed at a separator or may be preferably provided at a manifold formed at the “frame” accommodating an MEA. An MEA is a composite member containing a polymer electrolyte membrane, together with a pair of electrodes constituting a fuel electrode and an oxidizing electrode and sandwiching the polymer electrolyte membrane. An MEA is accommodated in a frame or preferably encompassed by a frame. The separators are arranged at both surfaces of the MEA accommodated in the frame.

In the following, a member integrating the MEA and the frame accommodating the MEA may also be referred to as “frame-integrated MEA.”

The frame is normally made of resin. The examples of this resin include polypropylene. The manifold for supplying and exhausting fuel gas and the manifold for supplying and exhausting oxidizing gas are formed at the frame. Further, a manifold for flowing coolant may also be formed at the frame.

Among the manifolds formed at the frame accommodating the MEA, it is preferable for the internal space of at least one of the manifold (preferably supply manifold) for supplying and exhausting fuel gas and the manifold (preferably supply manifold) for supplying and exhausting oxidizing gas to be separated by a projecting part or a bridging part provided at the inner wall.

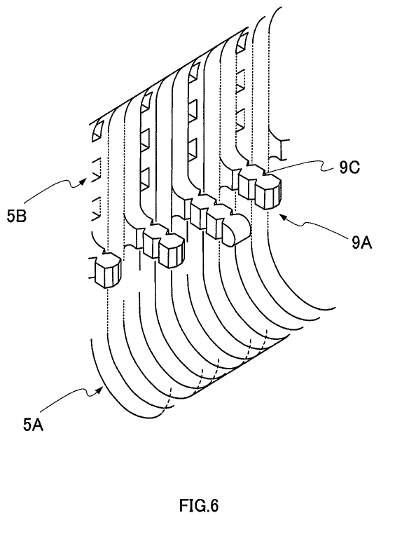

The projecting part may have one or more notches (refer to FIG. 6) so as to be cut at the notch so that it is possible to eliminate tips of the projecting part.

As described in the following, in a fuel cell stack of the present invention, the height of the projecting part changes according to each of the stacked cells. It is therefore possible to produce a fuel cell stack of the present invention in a straightforward manner by forming a notch at the projection part and stacking the cells each of which the height of the projection part is appropriately adjusted.

It is also preferable for sealant to be formed at the frame of the frame-integrated MEA. The sealant may encompass the manifolds and the MEA, and prevent fluid flowing within the manifolds from leaking to outside.

The frame of the frame-integrated MEA of the present invention may be made by using an arbitrary method as long as the method is not detrimental to the effects of the invention. The frame of the frame-integrated MEA of the present invention may preferably be made by using an injection molding method. An injection molding method is a one of hardening molten resin flowed into a die from a gate so as to obtain the desired molding. It is preferable to provide a gate at part of a projecting part or bridging part when a projecting part or bridging part is formed at the inner wall of a manifold of the frame. In injection molding, more stable forming can be achieved by restricting the flow of resin into the die with one direction, so it is sometime preferable to provide a gate at the projecting part.

Typically, a residual gate is formed at a mold after injection molding and it is necessary to remove the residual gate. However, if a gate is provided at a projecting part or bridging part, there is no problem when the gate remains as the projecting or bridging part. Therefore, the elimination process for the residual gate is no longer necessary, and the number of steps and production time can be reduced.

The fuel cell stack of the present invention contains a plurality of stacked cells, and the structure of the projecting part and bridging part formed at supply manifold varies by each of cells. Namely, the ease of inflow of the reactive gas to the “space connected with the separator flow path” of the supply manifold varies by each of the cells.

Among the stacked cells contained in the cell stack of the present invention, it is preferable for a cell of which the inflow is least active to be internally stacked. The internally stacked cell is preferably cell for up to half of the whole of the stacked cells from the side supplying reactive gas (fuel gas or oxidizing gas) from outside, and still more preferably one quarter of the cell for the inner layer from the supply side.

The present inventors have noticed that regarding a fuel cell stack containing a plurality of stacked cells, gas supplied from an external gas supply pipe to a supply manifold reaches the supply manifold for a cell of the inner layer for up to first half-way from the supply side in a short period of time, and reaches a cell at one quarter of the whole of the stacked body in the direction of stacking from the inlet of the pipe supplying gas from outside in the shortest period of time. Based on this knowledge, the present inventors have furthermore noticed that it is possible to supply gas in a uniform manner in a short period of time to all of the cells by making it difficult for the gas to flow in to the “space connected with the separator flow path” of the cell of the inner layer for up to the first half-way from the supply side.

It is preferable for the supplying and exhausting pipe sections of the manifolds of each stacked cell to mutually communicate in the fuel cell stack of the present invention. More preferable is that the “space connected with the separator flow path” of the respective supplying and exhaust manifold mutually communicates with each other. The uniformity and straightening of the supplied gas are promoted to a greater extent if the every space connected with the separator flow path communicates with each other.

The fuel cell stack of the present invention preferably has the plane surface of each cell arranged parallel with respect to a gravitational direction. On the other hand, the plane surface of each cell is not arranged perpendicularly with respect to a gravitational direction. Further, it is also preferable for the fuel cell stack to be such that the “space connected with the separator flow path” of the manifold where the projecting part or bridging part is formed is arranged further upwards with respect to a gravitational direction than the “other space (for example, the supplying/exhaust pipe section).” By that means, when moisture contained in reactive gas supplied from outside forms dew condensation in the manifold, flow of the moisture into the separator flow path is inhibited, and accumulating of the moisture in the separator flow path is prevented.

The following is a description of the present invention with reference to the drawings.

### EMBODIMENT 1

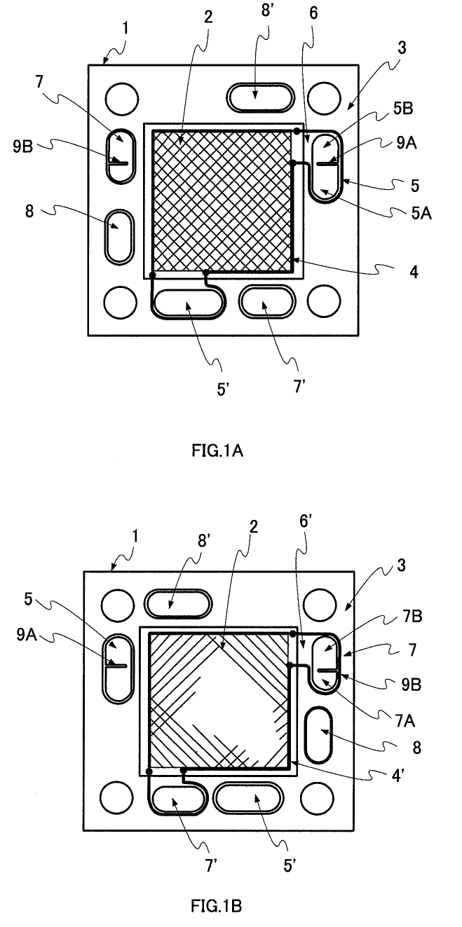

An example of a frame-integrated MEA is shown in FIG. 1. FIG. 1A is a front view of a frame-integrated MEA 1 from the cathode side, and FIG. 1B is a front view of the frame-integrated MEA 1 from the anode side.

In FIG. 1A and FIG. 1B, frame 3 is formed about the periphery of MEA 2. Seal 4 (FIG. 1A) and seal 4′ (FIG. 1B) are formed on frame 3. Seal 4 is formed so as to envelope cathode side manifolds 5/5′ for supplying/exhausting oxidizing gas and MEA 2, but is not formed at portion 6 communicating between cathode side manifolds 5/5′ and MEA 2 (FIG. 1A). Further, seal 4′ is formed so as to envelope anode side manifolds 7/7′ for supplying/exhausting fuel gas and MEA 2, but is not formed at portion 6′ communicating between anode side manifolds 7/7′ and MEA 2 (FIG. 1B). Seal 4/4′ prevents gas from leaking. Further, the seals are formed so as to wrap around cooling water manifolds 8 and 8′ and prevent cooling water from leaking to outside.

Projecting part 9A is provided at part of an inner wall of cathode side supply manifold 5 and projecting part 9A projects from the outer periphery side towards MEA 2. Projecting part 9A is arranged so as to divide an internal space of manifold 5 into space 5B connected with the separator flow path and supply/exhaust pipe section 5A.

Projecting part 9B is also provided at part of an inner wall of anode side supply manifold 7 and projecting part 9B projects from the outer periphery side towards MEA 2. Projecting part 9B is arranged so as to divide an internal space of manifold 7 into space 7B connected with the separator flow path and supply/exhaust pipe section 7A.

The size of MEA 2 is, for example, 150 mm high and 150 mm wide. The size of the frame 3 is, for example, 220 mm high and 220 mm wide. And the material of the frame 3 is resin such as polypropylene. Seal 4 can be formed through two colors forming fluoro rubber.

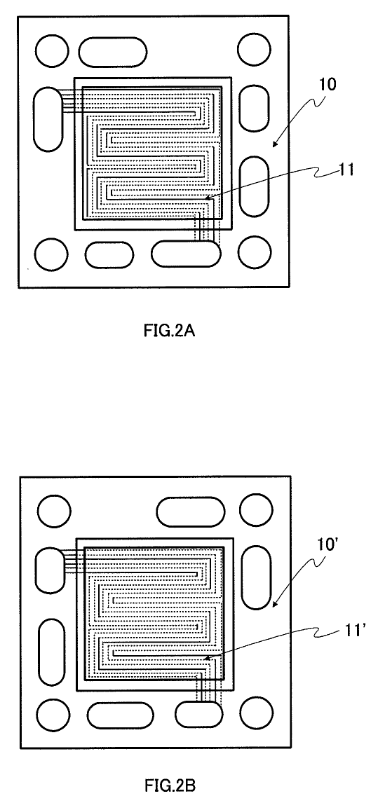

A cathode side front view of cathode side separator 10 is shown in FIG. 2A, and an anode side front view for anode side separator 10′ is shown in FIG. 2B. Gas flow paths 11 and 11′ are formed on 10 and 10′.

A cathode surface of cathode side separator 10 of FIG. 2A and a cathode surface of frame-integrated MEA 1 shown in FIG. 1A come into contact with each other. Further, an anode surface of anode side separator 10′ of FIG. 2B and an anode surface of frame integrated MEA 1 shown in FIG. 1B come into contact with each other. As a result of these, a fuel cell can be produced.

Fuel cell stack 100 where a plurality of fuel cells is stacked is shown in FIG. 3. The height of projecting part 9A each of the stacked cells is not uniform but varies. Namely, the height of projecting part 9A is a maximum at a certain cell of inner layer and the nearer a cell is stacked surface layers the smaller the height of projecting part of the cell becomes. Namely, the portion of gas passing through from supply/exhaust pipe section 5A to space 5B of the manifold connected with the separator flow path becomes smaller away from a position of connection of gas supply pipe 12 to the certain cell of inner layer along the stacking direction, is a minimum at the certain cell of inner layer and then becomes sequentially larger away from the certain cell of inner layer along the stacking direction.

The height of each projecting part 9B of each of the stacked cells is also not uniform but varies.

### EMBODIMENT 2

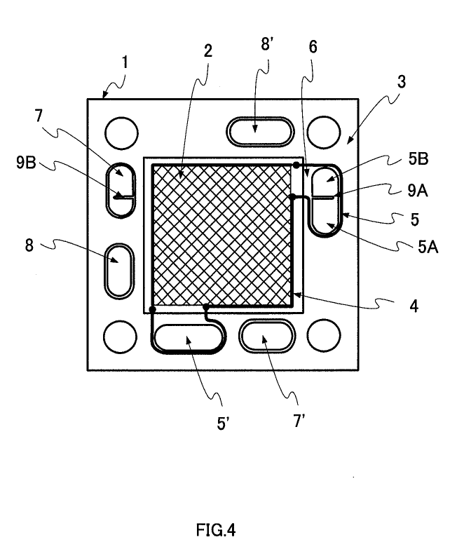

A front view from the cathode side of a further example of a frame-integrated MEA is shown in FIG. 4.

Projecting part 9A projecting in a direction towards the outside of the frame are also provided at the inner wall of cathode side supply manifold 5. Projecting part 9A is arranged so as to separate supply manifold 5 into a space 5B connected with separator flow path and supply/exhaust pipe section 5A. Similarly, projecting part 9B projecting in a direction towards the outside of the frame are also provided at the inner wall of anode side supply manifold 7. Other symbols correspond to symbols of FIG. 1.

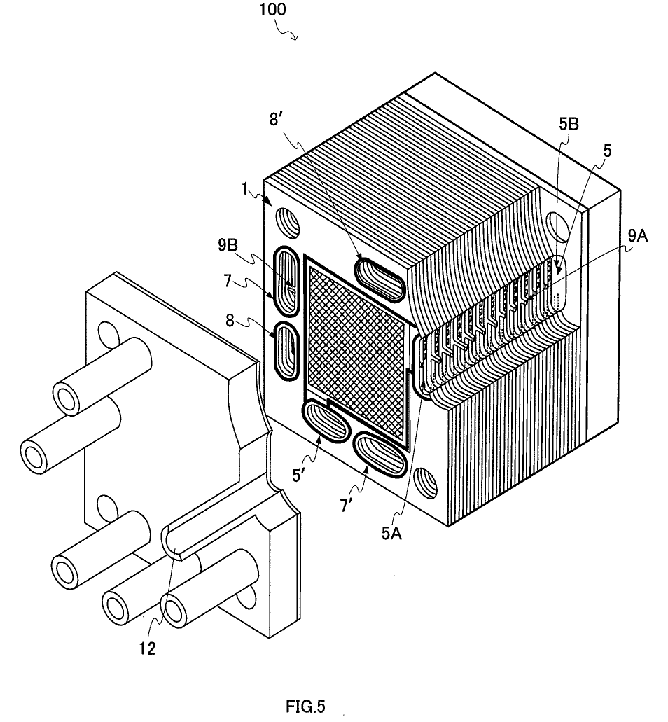

A fuel cell stack 100 consists of stacked cells including the frame-integrated MEA shown in FIG. 4 is shown in FIG. 5. The height of projecting part 9A of each of the stacked cells is not uniform and varies. Namely, the height of a projecting part 9A is a maximum at a certain cell of inner layer and the nearer a cell is stacked surface layers the smaller the height of projecting part of the cell becomes. Namely, the portion of gas passing through from supply/exhaust pipe section 5A to space 5B of the manifold connected with the separator flow path becomes smaller away from a position of connection of gas supply pipe 12 to the certain cell of inner layer along the stacking direction, is a minimum at the certain cell of inner layer and then becomes sequentially larger away from the certain cell of inner layer along the stacking direction.

The height of each projecting part 9B of the stacked cells is also not uniform but varies.

### EMBODIMENT 3

FIG. 6 is an enlarged view of an example of a supply manifold supplying gas.

A plurality of notches 9C is provided at projecting part 9A. It is possible to cut the end of the projecting part 9A at the notch 9C. When notches 9C are provided at projecting part 9A of the frame of the frame-integrated MEA, it is possible to cut one of the notches 9C so as to adjust the length of the projecting part according to order of stacking of the stacked cells.

This makes adjustment of gas passing through to the space 5B connected with the separator flow path from supply/exhaust pipe section 5A straightforward, and also easily makes variation such as shown in FIG. 3 and FIG. 5.

### EMBODIMENT 4

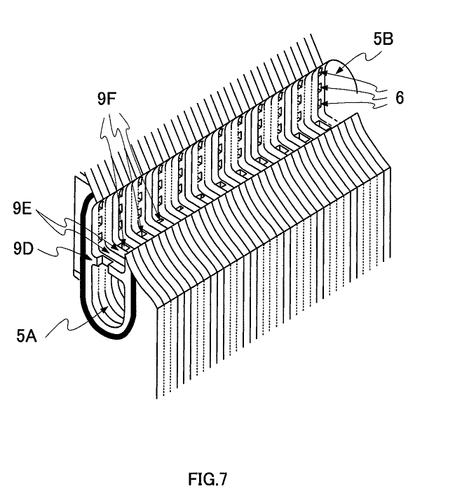

FIG. 7 is an enlarged view of a cathode side supply manifold of a fuel cell stack where cells containing frame integrated MEAs are stacked. In FIG. 7, a manifold of the frame-integrated MEA and a manifold of the separator are tightly fitted together. The frame of the frame-integrated MEA has bridging part 9D, and the separator has bridging part 9E.

Bridging part 9D and bridging part 9E divide the manifold into supply/exhaust pipe section 5A and space 5B connected with the separator flow path (connecting section 6 connecting the separator flow path with manifold is present at space 5B). Gas flow path 9F is present at bridging part 9D and communicates with space 5B connected with the separator flow path and supply/exhaust pipe section 5A.

The area of gas flow path 9F formed at bridging part 9D is not uniform but varies. The area of gas flow path 9F at a certain cell of inner layer is made smallest, and the nearer a cell is stacked surface layers the larger the area of gas flow path 9F of the cell becomes. Namely, the area of gas flow path 9F becomes smaller away from a position of connection of gas supply pipe 12 to the certain cell of inner layer along the stacking direction, is a minimum at the certain cell of inner layer and then becomes sequentially larger away from the certain cell of inner layer along the stacking direction.

### EMBODIMENT 5

FIG. 8 is an enlarged view of a cathode side supply manifold of a fuel cell stack where cells containing frame integrated MEAs are stacked.

Projecting part 9G formed at the frame of frame-integrated MEA is a current plate having a cross-section of flat plate. Angle 16 of longitudinal direction 14 of the current plate and staking direction 15 of the cells is not uniform but varies by each of the stacked cells. Namely, angle 16 is a minimum at a certain cell of inner layer, and the nearer a cell is stacked surface layers the lager the angle 16 of the cell becomes. In other words, angle 16 becomes smaller away from a position of connection of gas supply pipe 12 to the certain cell of inner layer along the stacking direction, is a minimum at the certain cell of inner layer and then becomes sequentially larger away from the certain cell of inner layer along the stacking direction.

### EMBODIMENT 6

FIG. 9 is an enlarged view of a cathode side supply manifold of a fuel cell stack where cells containing frame integrated MEAs are stacked.

Bridging part 9H formed at the frame of frame-integrated MEA is a current plate having a cross-section of flat plate. Angle 16 of longitudinal direction 14 of the current plate and staking direction 15 of the cells is not uniform but varies by each of the stacked cells. Namely, angle 16 is a minimum at the certain cell of inner layer, and the nearer a cell is stacked surface layers the larger the angle 16 of the cell becomes. In other words, angle 16 becomes smaller away from a position of connection of gas supply pipe 12 to the certain cell of inner layer along the stacking direction, is a minimum at the certain cell of inner layer and then becomes sequentially larger away from the certain cell of inner layer along the stacking direction.

### EMBODIMENT 7

FIG. 10 is an enlarged view of a cathode side supply manifold of a fuel cell stack where cells containing frame integrated MEAs are stacked.

The tip of the projecting part 9I formed at the frame of the frame-integrated MEA is thicker in the stacking direction than portion other than for the tip, and has a hole 9J at the center. The cross-section of hole 9J is substantially circular. The every tip part of projecting part 9I fits together to form pipe 9K, and a pipe for supplying gas from outside is connected to the end in a stacking direction of the formed pipe 9K. The space for 5A acts as a buffer section in order to ensure that gas supplied from outside does not enter 5B rapidly.

Further, a gas ejecting opening 9L is provided at the side surface of the formed pipe 9K. The area of ejecting opening 9L is not uniform but varies by each of the stacked cells. Namely, the surface area of ejecting opening 9L is a minimum at a certain cell of inner layer, and the nearer a cell is stacked surface layers the lager the area of ejecting opening 9L of the cell becomes. In other words, the area of ejecting opening 9L becomes smaller away from a position of connection of gas supply pipe 12 to the certain cell of inner layer along the stacking direction, is a minimum at the certain cell of inner layer and then becomes sequentially larger away from the certain cell of inner layer along the stacking direction.

### EMBODIMENT 8

FIG. 11 is an enlarged view of a cathode side supply manifold of a fuel cell stack where cells containing frame integrated MEAs are stacked.

The central part of bridging part 9M formed at the frame of the frame-integrated MEA is thicker in the stacking direction than portions other than for the central part, and has a hole 9J at the center. The cross-section of hole 9J is substantially circular. The every central part of bridging part 9M fits together to form pipe 9N, and a pipe for supplying gas from outside is connected to the end in a stacking direction of the formed pipe 9N. The space for 5A acts as a buffer section in order to ensure that gas supplied from outside does not enter 5B rapidly.

Further, a gas ejecting opening 9L is provided at the side surface of the formed pipe 9N. The area of ejecting opening 9L is not uniform but varies by each of the stacked cells. Namely, the area of ejecting opening 9L is a minimum at a certain cell of inner layer, and the nearer a cell is stacked surface layers the lager the area of ejecting opening 9L of the cell becomes. In other words, the area of ejecting opening 9L becomes smaller away from a position of connection of gas supply pipe 12 to the certain cell of inner layer along the stacking direction, is a minimum at the certain cell of inner layer and then becomes sequentially larger away from the certain cell of inner layer along the stacking direction.

### EMBODIMENT 9

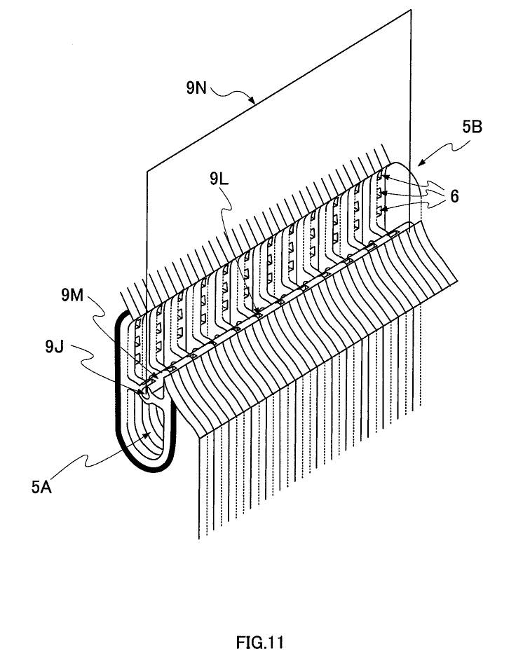

FIG. 12 is an enlarged view of a cathode side supply manifold of a fuel cell stack where cells containing frame integrated MEAs are stacked.

The tip part of the projecting part 9I formed at the frame of the frame-integrated MEA is thicker in the stacking directions than portions other than for the tip part, and has hole 9J at the center. The cross-section of hole 9J is substantially circular. The every central part of projecting part 9I fits together to form pipe 9K, and a pipe for supplying gas from outside is connected to the end in a stacking direction of the formed pipe 9K.

Further, gas ejecting opening 9L is present at a side surface of the formed pipe 9K, and the gas ejecting opening 9L faces towards the lower side of the drawings, i.e. faces in the opposite direction to space 5B connected with the separator flow path. Gas supplied from outside enters 5A (buffer section) temporarily before transferring to 5B, and the straightening effect is therefore high. The area of ejecting opening 9L is not uniform but varies by each of the stacked cells. Namely, the area of ejecting opening 9L is a minimum at a certain cell of inner layer, and the nearer a cell is stacked surface layers the lager the area of ejecting opening 9L of the cell becomes. In other words, the area of ejecting opening 9L becomes smaller away from a position of connection of gas supply pipe 12 to the certain cell of inner layer along the stacking direction, is a minimum at the certain cell of inner layer and then becomes sequentially larger away from the certain cell of inner layer along the stacking direction.

### EMBODIMENT 10

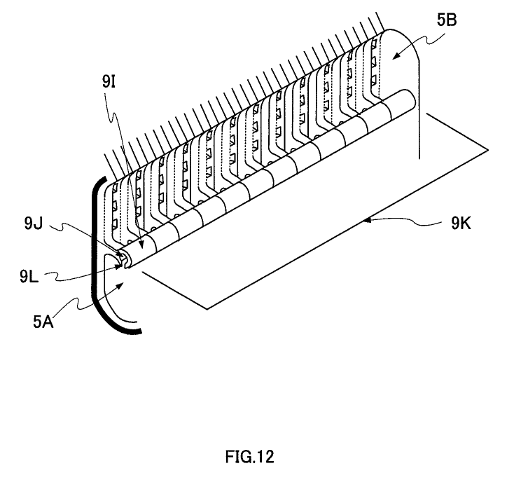

FIG. 13 is an enlarged view of a cathode side supply manifold of a fuel cell stack where cells containing frame integrated MEAs are stacked.

The central part of bridging part 9P formed at the frame of the frame-integrated MEA is thicker in the stacking direction than portions other than for the central part, and has hole 9J. The cross-section of hole 9J is substantially circular. The every central part of bridging part 9P fits together to form pipe 9Q, and a pipe for supplying gas from outside is connected to the end in a stacking direction of the formed pipe 9Q.

Further, gas ejecting opening 9L is present at a side surface of the formed pipe 9Q and faces towards the lower side of the drawing, i.e. in a direction opposite to the direction of the space 5B including section 6 connecting the separator flow path. Gas supplied from outside enters 5A (buffer section) temporarily before transferring to 5B, and the straightening effect is therefore high. The area of ejecting opening 9L is not uniform but varies by each of the stacked cells. Namely, the area of ejecting opening 9L is a minimum at a certain cell of inner layer, and the nearer a cell is stacked surface layers the lager the area of ejecting opening 9L of the cell becomes. In other words, the area of ejecting opening 9L becomes smaller away from a position of connection of gas supply pipe 12 to the certain cell of inner layer along the stacking direction, is a minimum at the certain cell of inner layer and then becomes sequentially larger away from the certain cell of inner layer along the stacking direction.

### EMBODIMENT 11

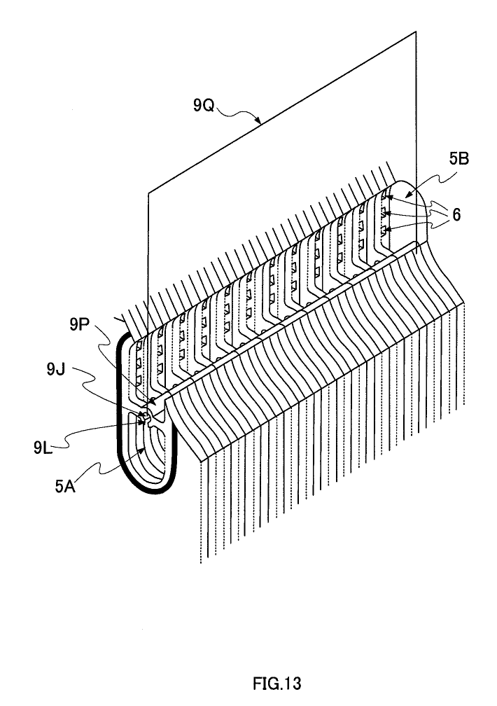

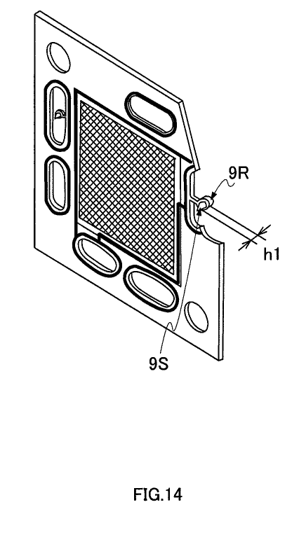

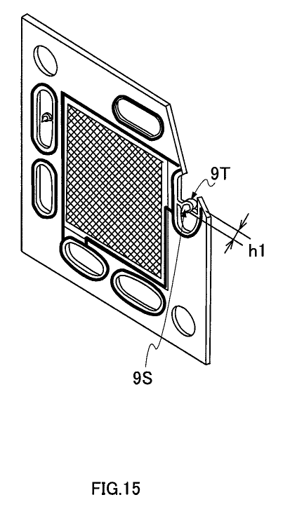

An example of a frame-integrated MEA is shown in FIG. 14 and FIG. 15. Projecting part 9R is formed at an inner wall of the frame-integrated MEA of FIG. 14, and bridging part 9T is formed at the inner wall of the manifold of the frame-integrated MEA of FIG. 15.

As described above, the frame 3 is made through injection molding method, and it is preferable to take tip 9S of projecting part 9R as the gate for injection molding and to inject resin into a die through the gate (refer to FIG. 14). Similarly, it is also preferable to take central part 9S of bridging part 9T as the gate for injection molding and to inject resin into a die through the gate (refer to FIG. 15).

The height h1 in the stacking direction of gate 9S is substantially the same as the thickness of the frame and preferably does not exceed the total thickness of the anode side separator and the cathode side separator.

### EXAMPLES

### Example 1

Acetylene black carbon particles are supported 25% by weight with platinum particles having an average particle size of 30 Å to prepare the cathode catalyst.

Further, acetylene black carbon particles are supported 25% by weight with platinum-ruthenium alloy particles having an average particle size of 30 Å to prepare the anode catalyst.

These particles are dispersed in isopropyl alcohol and mixed with ethyl alcohol dispersion liquid of perfluorocarbonsulfonic acid resin powder so as to obtain a paste. The obtained pastes are then applied to the surfaces of carbon nonwoven fabric of thickness 250μ m with screen printing techniques so as to prepare a catalyst layer. The amount of catalyst metal contained in the catalyst layer for each electrode is 0.3 mgc/m², and the amount of perfluorocarbon sulfonic acid resin is 1.2 mgc/m².

With the exception of the catalyst material, the electrodes (including cathode and anode) have the same structure. A solid polymer electrolyte membrane having an area substantially larger than that of the electrodes is also prepared. The solid polymer electrolyte membrane is perfluorocarbon sulfonic acid resin in the form of a thin membrane 30 μm thick.

The electrodes (including cathode and anode) are arranged at each surface of the central part of the solid polymer electrolyte membrane. 250 μm-thick fluorocarbon rubber sheets press-cut to a predetermined size are arranged on both sides so as to sandwich the electrolyte membrane at the outer peripheral parts of the electrodes, this is joined so as to be integral by hot pressing, and an MEA is made.

The frame-integrated MEA shown in FIG. 1 and the separators shown in FIG. 2 are then made.

The cathode side manifold of the frame of the frame-integrated MEA is 10 mm wide and 30 mm long, the anode side manifold is 10 mm wide and 20 mm long, and the shape of the manifolds is an ellipse wherein R of four corners is 15. The supply manifolds are then arranged so that the long axis of the ellipse is parallel to the gravitational direction.

Further, projecting parts 9A and 9B are formed facing to the electrode side at the lowermost position of portion 6 connecting the manifold with electrode, at the outer side of inner wall of the supply manifold. The width of the projecting parts is 1.5 mm. The lengths of the projecting parts are 3 mm to 9 mm at 2 mm intervals, and four types of projecting part are made.

A conductive cathode separator, frame integrated MEA, and conductive anode separator are stacked so as to assemble a cell. Fifty cells are then stacked. The length of the projecting part of the manifold varies by each of the stacked cells, and is maximal at one quarter of the whole of the stacked body in the direction of stacking from the connecting section of the pipe supplying gas from outside.

The obtained stacked body is then sandwiched by a collecting plates composed of sheet copper with gold plated surfaces, this is further sandwiched by insulating plates of polyphenylene sulfide, and further sandwiched by stainless steel end plates. Both end plates are then fastened with a fastening rod so as to obtain a cell stack. At this time, fastening pressure is 100N/cm² per unit area of electrode. It is then possible to extract power by attaching a cable to the collecting plates. The stainless steel end plates then ensure the strength of the cell stack.

The cell stack is then installed so that the plate surface of the separator is parallel to the gravitational direction, and cooling water intake manifold 8 is higher up with respect to the gravitational direction. A serpentine type gas flow path (comprised of a liner part for the horizontal direction and a turn part) formed on the separator is such that reactive gas flows downstream with respect to the gravitational direction.

### Comparative Example 1

With the exception that the internal structure of the cathode side supply manifold and anode side supply manifold of the frame integrated MEA of the fuel cell stack of example 1 is made as illustrated in FIG. 16, the fuel cell stack is made with the same method of example 1. Namely, there are no projections or bridging parts at the inner walls of the manifold of the fuel cell stack of comparative example 1. The reactive gas is supplied in a direction towards the back along axis 13 from the front with respect to the paper surface, passes through section 6 connecting the electrodes with the manifold, and is distributed and supplied to electrodes of each cell.

### Comparative Example 2

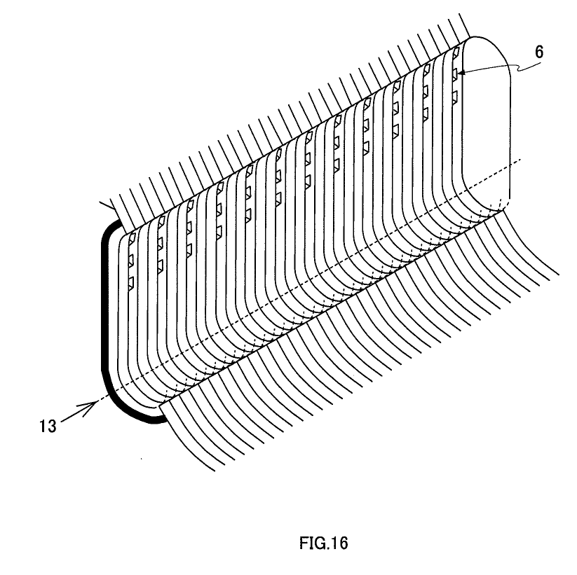

With the exception that the internal structure of the cathode side supply manifold and anode side supply manifold of the frame integrated MEA of the fuel cell stack of example 1 is made as illustrated in FIG. 17, the fuel cell stack is made with the same method of example 1. Namely, projecting parts 9A are provided at the inner walls of the manifold of the fuel cell stack of comparative example 2. The lengths of all of the projecting parts 9A of the cells are equal at 7 mm. Reactive gas is supplied along axis 13 from the front with respect to the paper surface. The gas supplied to supply/exhaust pipe section 5A transfers to space 5B connected with the separator flow path, and is further distributed and supplied to electrode of each cell through section 6 connecting the electrode with manifold.

### Comparative Example 3

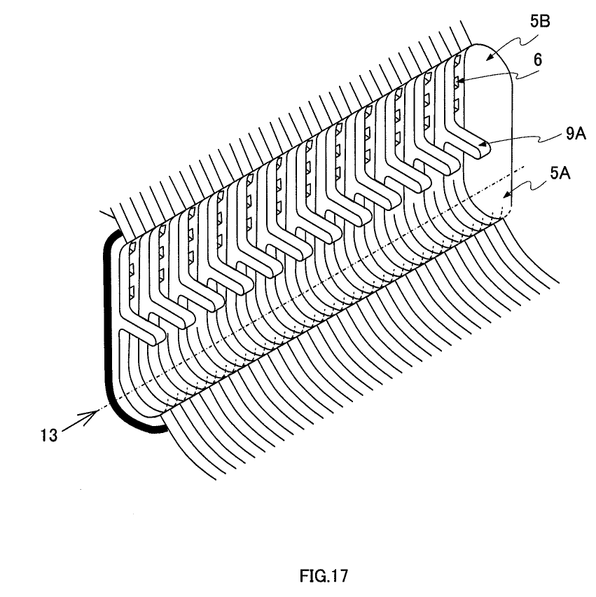

With the exception that the structure of the frame-integrated MEA for the fuel cell stack is made as illustrated in FIG. 18, the frame-integrated MEA for the fuel cell stack is made with the same method of comparative example 2. Namely, space 5B connected with the separator flow path is arranged lower than supplying/exhausting side 5A with respect to the gravitational direction. Reactive gas is supplied into a portion of the supply/exhaust section 5A from the front of the paper surface, is transferred to space 5B connected with the separator flow path, and is further distributed and supplied to electrode of each cell through section 6 connecting the electrode with manifold.

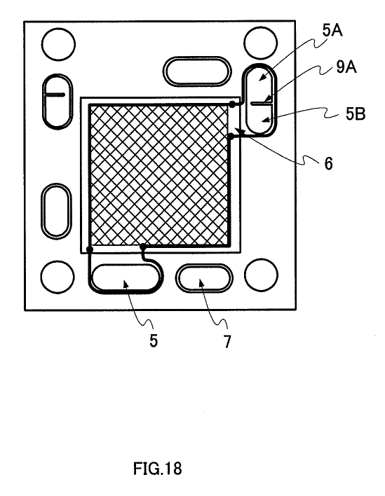

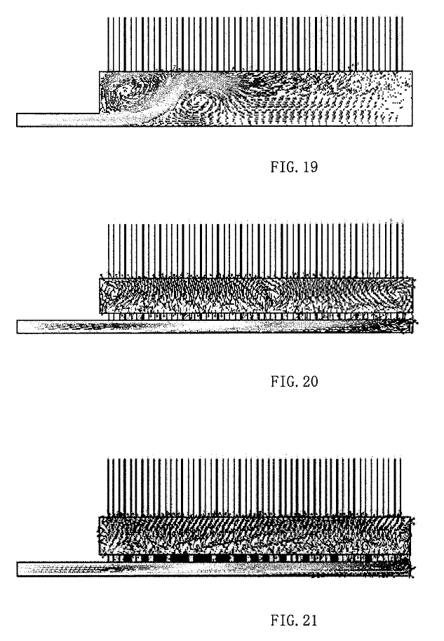

The cathode side supply/exhaust manifold and the cathode side separator flow paths of the fuel cell stack of comparative example 1, comparative example 2, and example 1 are filled with 100% nitrogen with a 75 degree dew point. Air with a 75 degree dew point is then made to flow in to the supply manifold from the gas supply pipe while maintaining a state of 75 degree. The results of simulating the concentration distribution of the air within the cathode side supply manifold two seconds after the flowing in are shown in FIG. 19 (comparative example 1), FIG. 20 (comparative example 2), and FIG. 21 (example 1).

At the cathode side supply manifold in FIG. 19 (comparative example 1), inflowing air is collected to the region of the manifold at a approximately one quarter from the gas supply pipe inlet (left in the drawing) to the rear (right in the drawings) in the stacking direction. Turbulence then occurs in the vicinity of the gas supply pipe inlet opening (left end in the drawings) and at the rear in the stacking direction (right end in the drawing). The inflow of air becomes blocked up, and particularly, in the rear region (right end in the drawing) a high concentration of the nitrogen remains.

In the cathode side supply manifold in FIG. 20, the collected air as seen in comparative example 1 cannot be seen. This is because after static pressure recovery of the supplied air is sufficiently carried out at a portion (supply/exhaust pipe section) downwards with respect to the gravitational direction by the projecting part 9A, the air flows into portion (space connected with separator flow paths) upwards with respect to the gravitational direction through gaps between projecting parts 9A, and so the occurrence of drifting of the air in the stacking direction is minimized. However, it can also be seen that turbulence occurs in the vicinity of the gas supply pipe inlet (left end in the drawing) and at the rear in the stacking direction (right end in the drawing), and in the vicinity of the central part in the stacking direction (center in the drawings). Therefore the inconsistency in the concentration of the air still remains.

The simulation results (not shown) of comparative example 3 is the same as for FIG. 20. However, when generation of power was tried with the fuel cell stack of comparative example 3, the voltage generated by the cell close to the position of connecting the gas supply pipe is unstable. And it can be confirmed that this phenomena is marked particularly at the time of low load operation when the amount of gas flow is small. This is because the temperature of the inner wall of the manifold becomes lower than the temperature of supplied gas since the portion in which the supplied gas flows is away from the power generating member, and it therefore becomes easy for dew condensation water to occur. Further, space 5B connected with the separator flow path is lower than gas supply/exhaust pipe 5A with respect to the gravitational direction. It is therefore easy for part of the dew condensation water to infiltrate into the separator flow path and the flow path is made to be closed.

At the cathode side supply manifold of FIG. 21 (example 1), the collected air as seen in comparative example 1 cannot be seen. And more, inconsistency of air concentration in the vicinity of the gas supply pipe inlet (left end in the drawing) and in the rear in the stacking direction (right end in the drawing) seen in comparative example 2 cannot be seen.

This is because static pressure recovery of supplied air is carried out in a sufficient manner at low portion (supply/exhaust pipe section) with respect to the gravitational direction by projecting parts 9A provided at the inner wall of the manifold. And because a shift in timing of transfer of the air subjected to the static pressure into the section communicating with the separator flow path at each cell is minimized.

Minimization of the shift in timing is achieved by making the length of projecting part 9A largest at portion that is most susceptible to dynamic pressure, i.e. at the approximately at one quarter of the whole of the stacked body from the gas supply pipe inlet (left side of the drawing) to the back (right side in the drawing) along the stacking direction, and by making the lengths vary towards the left side and towards the right side from the portion. The effectiveness of the present invention can be confirmed from these results.

### Example 2

In example 2, a fuel cell stack is produced in the same way as for example 1 with the exception that projecting parts of the cathode side supply manifold of the frame-integrated MEA are as described in the following.

Projecting parts 9A and 9B are formed facing to the outside at the lowermost position of portion 6 connecting the manifold with electrode, of the manifold inner wall (refer to FIG. 4). The width of projecting parts 9A and 9B is 1.5 mm. The lengths of the projecting parts are 3 mm to 9 mm at 2 mm intervals, and four types of the projecting parts are made.

The projecting parts of the manifold are formed to have gradient in length. The length of the projecting part of the cell stacked in one quarter of the whole of the stacked body from the inlet of the pipe supplying gas in the stacking direction is maximal.

### Example 3

In example 3, a fuel cell stack is produced in the same way as for example 1 with the exception that projecting parts of the cathode side supply manifold of the frame-integrated MEA are as described in the following.

Projecting parts 9A and 9B are formed facing to the outside at the lowermost position of portion 6 connecting the manifold with electrode, of the manifold inner wall.

The width of projecting parts 9A and 9B is 1.5 mm. The length of the projecting part is 9 mm, and wedge-shaped notches of width 0.3 mm and depth 0.5 mm are formed at positions of 2 mm, 4 mm, and 6 mm from the tips of the projecting part (refer to FIG. 6).

When the cells are stacked, none or one of the notches is selected according to the order of stacking, then cut from there, and the lengths of the projections are adjusted to 9 mm, 7 mm, 5 mm and 3 mm.

The length of the projecting part of the manifold for the cell is maximal at one quarter of the whole of the stacked body from the inlet of the pipe supplying gas in the stacking direction, and the length is varies by each cell.

It can also be confirmed that, in simulation of air concentration distribution within the cathode side supply manifold of the fuel cell stack of example 3, the air concentration is substantially uniform as with example 2. When comparing with example 1, the cost of the die production is substantially reduced, and it is possible to substantially shorten the producing time including the time for changing the die.

### Example 4

In example 4, a fuel cell stack is produced in the same way as for example 1 with the exception that projecting parts of the cathode side supply manifold of the frame integrated MEA are as described in the following.

A bridging part 1.5 mm wide is provided at a part lower than section 6 connecting the electrodes with the manifolds of the inner wall of the manifold. Rectangular holes 9F of depth 1.5 mm are formed at this bridging part (refer to FIG. 7). The lengths of rectangular holes 9F are 2 mm, 4 mm, 6 mm and 8 mm.

The length of the rectangular hole of the bridging part of the manifold for the cell is minimal at one quarter of the whole of the stacked body from the inlet of the pipe supplying gas in the stacking direction, and the length is varies by each cell. In the example 4, compared with the example 2, the time for switching over between the pre-filled nitrogen and the supplied air is longer but air concentration distribution within the manifold is confirmed to be more uniform.

### Example 5

In example 5, a fuel cell stack is produced in the same way as for example 1 with the exception that projecting parts of the cathode side supply manifold of the frame-integrated MEA are as described in the following.

Projecting part 9G facing towards the outside is formed at the manifold inner wall (refer to FIG. 8). The cross-section of projecting part 9G is elliptical with a long axis of 1.5 mm and a short axis of 0.5 mm. The angle formed by the long axis of the ellipse and the stacking direction is 90 degrees, 60 degrees, 30 degrees, and 0 degrees.

The angle regarding the projecting part of the manifold for the cell is minimal at one quarter of the whole of the stacked body from the inlet of the pipe supplying gas in the stacking direction, and the length is varies by each cell.

In example 5, it is possible to confirm that the straightening action of the projections having an ellipsoidal cross-section achieve a more uniform air concentration distribution within the manifold than example 1 without delays occurring when switching over between the pre-filled nitrogen and the supplied air as in example 4.

### Example 6

In example 6, a fuel cell stack is produced in the same way as for example 1 with the exception that projecting parts of the cathode side supply manifold of the frame-integrated MEA are as described in the following.

A bridging part 9H is provided at a part lower than section 6 connecting the electrode and the manifold at the inner wall of the manifold (refer to FIG. 9). The cross-section of bridging part 9H is elliptical with a long axis of 1.5 mm and a short axis of 0.5 mm, and a width of 1.5 mm. The angle formed by the long axis of the ellipse and the stacking direction is 90 degrees, 60 degrees, 30 degrees, or 0 degrees.

The angle regarding the projecting part of the manifold for the cell is minimal at one quarter of the whole of the stacked body from the inlet of the pipe supplying gas in the stacking direction, and the angle is varies by each cell.

In example 6, it is possible to confirm that the straightening action of the projections of an ellipsoidal cross-section achieve a more uniform air concentration distribution within the manifold than example 1 without delays occurring when switching over between the pre-filled nitrogen and the supplied air. Moreover, compared with example 5, the bridging part of the frame-integrated MEA of example 6 has a high rigidity and is subjected to little change in shape after molding, and therefore it is possible to prevent misalignment in assembling.

### Example 7

In example 7, a fuel cell stack is produced in the same way as for example 1 with the exception that projecting parts of the cathode side supply manifold of the frame-integrated MEA are as described in the following.

Projecting part 9I 1.5 mm wide facing towards the outside is also provided at the manifold inner wall (refer to FIG. 10). A pipe is formed at the tip of projecting part 9I. The outer diameter of the pipe is 5 mm, the inner diameter is 3 mm. The length of the pipe is 0.05 mm shorter than the total thickness (9 mm) of the frame-integrated MEA and the separator.

A rectangular hole 9L is provided on the upper surface of this pipe, and is 3 mm wide and 7 mm, 5 mm, 3 mm or 1 mm long in the stacking direction.

Each cell is stacked so as to substantially connect the pipe of the cell together. The length of the hole of the manifold for the cell is minimal at one quarter of the whole of the stacked body from the inlet of the pipe supplying gas in the stacking direction, and the length is varies by each cell.

In example 7, it is confirmed that switching over between the pre-filled nitrogen and the supplied air is achieved in a shorter period of time than example 1 as a result of the distributing action of pipe holes 9J, and therefore the air concentration distribution within the manifold is more uniform.

### Example 8

In example 8, a fuel cell stack is produced in the same way as for example 1 with the exception that projecting parts of the cathode side supply manifold of the frame-integrated MEA are as described in the following.

A bridging part 9M 1.5 mm wide is formed below the portion 6 connecting the manifold with the electrode (refer to FIG. 11). A pipe is formed at a central part of bridging part 9M. The external diameter of the pipe is 5 mm, the internal diameter 3 mm, and the length is approximately 0.05 mm shorter than the total thickness (9 mm) of the frame-integrated MEA and the separator.

A rectangular hole 9L is provided on the upper surface of the pipe, and is 3 mm wide and 7 mm, 5 mm, 3 mm or 1 mm long in the stacking direction.

Each cell is stacked so as to substantially connect with the pipe of the cell together. The rectangular holes are formed to have gradient in lengths. And a length of the hole of the cell stacked at one quarter of the whole of the stacked body from the inlet of the pipe supplying gas in the stacking direction is minimal.

In example 8, it is confirmed that switching over between the pre-filled nitrogen and the supplied air is achieved in a shorter period of time than example 1 as a result of the distributing action of pipe holes 9J, and therefore the air concentration distribution within the manifold is more uniform. Moreover, compared with example 7, the bridging part of the frame-integrated MEA has high rigidity and is subjected to little change in shape after molding. And therefore it is possible to prevent misalignment in assembling the fuel cell stack.

### Example 9

In example 9, a fuel cell stack is produced in the same way as for example 1 with the exception that projecting parts of the cathode side supply manifold of the frame-integrated MEA are as described in the following.

A projecting part 9I 1.5 mm wide is formed below the portion 6 connecting the manifold with the electrode (refer to FIG. 12). A pipe is formed at the tip of projecting part 9I. The external diameter of the pipe is 5 mm, the internal diameter 3 mm, and the length is approximately 0.05 mm shorter than the total thickness (9 mm) of the frame-integrated MEA and the separator. A rectangular hole 9L is provided on the lower surface of the pipe, and is 3 mm wide and 7 mm, 5 mm, 3 mm or 1 mm long in the stacking direction.

Each cell is stacked so as to connect with the pipe of the cell together. The rectangular holes are formed to have gradient in lengths. And a length of the hole of the cell stacked at one quarter of the whole of the stacked body from the inlet of the pipe supplying gas in the stacking direction is minimal.

In example 9, it is confirmed that switching over between the pre-filled nitrogen and the supplied air is achieved in a shorter period of time than example 1 as a result of the distributing action of pipe holes 9J, and therefore concentration distribution of the air within the manifold is more uniform. In example 9, compared to example 7, it can be seen that as a result of driving out a gas accumulated below the bridging part by dynamic pressure of the supplied gas, it is possible to minimize pulsing of electrical pressure because of little change of the concentration of the gas supplied to each cell under stable operation. As a result of that, a more stable operation is possible.

### Example 10

In example 10, a fuel cell stack is produced in the same way as for example 1 with the exception that bridging parts of the cathode side supply manifold of the frame integrated MEA are as described in the following.

A bridging part 9P 1.5 mm wide is formed below the portion 6 connecting the manifold with the electrode (refer to FIG. 13). A pipe is formed at a central part of bridging part 9P. The external diameter of the pipe is 5 mm, the internal diameter 3 mm, and the length is also approximately 0.05 mm shorter than the total thickness (9 mm) of the frame-integrated MEA and the separator.

Rectangular hole 9L is provided at the lower surface of the pipe. The width of the hole 9L is 3 mm and the length is 7 mm, 5 mm, 3 mm or 1 mm in the stacking direction.

Each cell is stacked so as to substantially connect with the pipe of the cell together. The rectangular holes are formed to have gradient in lengths. And a length of the hole of the cell stacked at one quarter of the whole of the stacked body from the inlet of the pipe supplying gas in the stacking direction is minimal.

In example 10, it is confirmed that switching over between the pre-filled nitrogen and the supplied air is achieved in a shorter period of time than example 1 as a result of the distributing action of pipe holes 9J, and therefore the air concentration distribution within the manifold is more uniform.

In example 10, compared to example 8, it can be seen that as a result of driving out a gas accumulated below the bridging part by dynamic pressure of the supplied gas, it is possible to minimize pulsing of electrical pressure because of little change of the concentration of the gas supplied to each cell under stable operation. As a result of that, a more stable operation is possible.

### Example 11

The frame of the frame-integrated MEA of example 11 is formed with injection molding techniques taking polypropylene (PP) resin as a source material. The position of injecting resin to the die (i.e. gate) corresponds to the bottom surface of a column (diameter 5 mm) formed at the tip of projecting part 9R (width 1.5 mm) projecting in a direction to outside from the inner wall of the cathode side supply manifold (refer to FIG. 14) The total of the height of the remaining gate 9S and the height h1 of the column is made to be smaller than the total of the thickness (9 mm) of the frame integrated MEA frame 3 and the separator (not shown in FIG. 14).

Since the position of injecting resin into the die corresponds to the tip of projecting part 9R, the processing of removing the remaining gate is no longer necessary, and the number of processes and producing time can be made shorter. Further, a central pipe hole and a rectangular hole for ejecting can be formed at the frame integrated MEA of example 11 in order to produce the frame integrated MEA of the example 7 or 9 (refer to FIG. 10 or FIG. 11).

### Example 12

At frame-integrated MEA of example 12 is formed with injection molding techniques taking polypropylene (PP) resin as a source material. The position of injecting resin to the die (i.e. gate) corresponds to the bottom surface of a column (diameter 5 mm) of a central part of bridging part 9T (width 1.5 mm) formed at a member lower than section 6 connecting the cathode side supply manifold with the electrode (refer to FIG. 15). The total of the height of the remaining gate 9S and the height h1 of the column is made to be smaller than the total of the thickness (9 mm) of the frame integrated MEA frame 3 and the separator (not shown in FIG. 14).

Since the position of injecting resin into the die corresponds to the central part of bridging part 9T, the processing of removing the remaining gate is no longer necessary, and the number of processes and producing time can be made shorter. Further, a central pipe hole and a rectangular hole for ejecting can be formed at the frame integrated MEA of example 12 in order to produce the frame integrated MEA of the example 8 or 10 (refer to FIG. 11 or FIG. 13).

In the examples described above, projecting parts and bridging parts are formed at the cathode side supply manifold but projecting parts and bridging parts may similarly be formed at anode side supply manifold or at both supply manifolds. It is therefore possible to switch over the input of gas in a short period at the time of starting up the fuel cell stack and changing output power of the fuel cell stack by adjustment the amount of fuel gas flowing.

### INDUSTRIAL APPLICABILITY

According to the polymer electrolyte type fuel cell stack of the present invention, not only supplying gas in a uniform manner to all stacked cells under steady operation is possible, but also supplying gas in a uniform manner in a short period of time under operation in transient states such as starting up, stopping, or when the load changes, etc is possible. It is therefore possible to stably switch operation and minimize deterioration in performance due to the switching operation, and improve reliability of the fuel cell stack. This fuel cell stack can be considered suitable for application in household cogeneration systems and application in vehicles.

The present application is based on Japanese Patent Application No. 2005-339944, filed on Nov. 25, 2005, the entire content of the specification, drawings and abstract being incorporated herein by reference.

1. A solid polymer fuel cell stack including a plurality of fuel cells stacked in series, each fuel cell comprising:
a polymer electrolyte membrane;
a pair of electrodes comprising a fuel electrode and an oxidizing electrode and sandwiching the polymer electrolyte membrane and;
a pair of separators comprising a separator connected to the fuel electrode and having a flow path where fuel gas flows and a separator connected to the oxidizing electrode and having a flow path where oxidizing gas flows;
a supply manifold that supplies fuel gas to the separator flow path where the fuel gas flows and an exhaust manifold that exhausts the fuel gas; and
a supply manifold that supplies oxidizing gas to the separator flow path where the oxidizing gas flows, and an exhaust manifold that exhausts the oxidizing gas, wherein:
an internal space of at least one of the supply manifold and the exhaust manifold is divided into two spaces mutually communicating that comprise a space connected with the separator flow path and an other space by a projecting part or a bridging part provided at an inner wall; and
the projecting part or the bridging part controls inflow of gas into the space connected with the separator flow path and the control of the inflow of gas varies between the plurality of stacked fuel cells, and the inflow of gas at fuel cell of inner layer is controlled to be minimal compared with the inflow of gas at fuel cells at end parts in a stacking direction.

2. The fuel cell stack of claim 1, wherein the inflow of gas is controlled to be minimal at fuel cell of inner layer positioned half-way or less across the whole of the stacked fuel cells from a side where gas is supplied from outside.

3. The fuel cell stack of claim 1, wherein:
the supply manifold supplying fuel gas to the flow path where the fuel gas flows and the exhaust manifold that exhausts the fuel gas, and the supply manifold supplying oxidizing gas to the flow path where the oxidizing gas flows and the exhaust manifold that exhausts the oxidizing gas, are formed in a frame; and
the solid polymer electrolyte membrane and the pair of electrodes comprised of the fuel electrode and the oxidizing electrode and sandwiching the solid polymer electrolyte membrane are accommodated in the frame.

4. The fuel cell stack of claim 3, wherein a sealant sealing the separator flow path from outside, is formed integrally in the frame.

5. The fuel cell stack of claim 1, wherein the every space connected with separator flow paths of the respective manifolds of the plurality of stacked fuel cells communicates with each other.

6. The fuel cell stack of claim 1, wherein the space connected with the separator flow path of the manifold is arranged higher than the other space with respect to the direction of gravitational force.

7. The fuel cell stack of claim 1, wherein the projecting part projects toward the electrode side from an outer periphery side of the fuel cell.

8. The fuel cell stack of claim 1, wherein a size of the projecting part or the bridging part is not uniform between the plurality of stacked fuel cells and is maximum at the fuel cell of the inner layer.

9. The fuel cell stack of claim 1, wherein a height of the projecting part is not uniform between the plurality of stacked fuel cells and is maximum at the fuel cell of the inner layer.

10. The fuel cell stack of claim 1, wherein:
the projecting part or bridging part contained at the respective plurality of stacked fuel cells is flat straightening plate; and
an angle of the straightening plate is not uniform, and an angle of a longitudinal direction of the straightening plate and the stacking direction of the fuel cells is minimal at the fuel cell of the inner layer.

11. The fuel cell stack of claim 1, wherein part of the projecting part or the bridging part contained at the respective plurality of stacked fuel cells is thicker in the stacking direction than other portions, and the part has an annular structure having a ejecting opening on its side;
the every part is tightly fitted with each other to form a pipe, and gas supply pipe from the outside is connected to the formed pipe; and
an area of the ejecting opening is not uniform and is minimal at the fuel cell at the inner layer.

12. The fuel cell stack of claim 11, wherein the ejecting opening faces in a direction opposite to the space connected with the separator flow path.

13. A frame comprising:
a polymer electrolyte membrane;
a pair of electrodes comprising a fuel electrode and an oxidizing electrode, and sandwiching the polymer electrolyte membrane; and
a supply manifold that supplies fuel gas to the separator flow path where the fuel gas flows and an exhaust manifold that exhausts the fuel gas; and
a supply manifold that supplies oxidizing gas to the separator flow path where the oxidizing gas flows and an exhaust manifold that exhausts the oxidizing gas, wherein:
an internal space of at least one of the supply manifold and the exhaust manifold is divided into a space connected with the separator flow path and an other space by projecting part provided at an inner wall, and
the projecting part has one notch or two or more notches, and the projecting part can be cut at the notch.

14. A method for producing a frame including:
a polymer electrolyte membrane;
a pair of electrodes comprising a fuel electrode and an oxidizing electrode and sandwiching the polymer electrolyte membrane; and
a supply manifold that supplies fuel gas to the separator flow path where the fuel gas flows and an exhaust manifold that exhausts the fuel gas; and
a supply manifold that supplies oxidizing gas to the separator flow path where the oxidizing gas flows, and an exhaust manifold that exhausts the oxidizing gas, wherein an internal space of at least one of the supply manifold and the exhaust manifold is divided into a space connected with the separator flow path and an other space by a projecting part or a bridging part provided at an inner wall, wherein:
the method comprising injecting resin into a die through a gate provided at the projecting part or bridging part.
